(19) United States
(12) Patent Application Publication
(10) Pub. No.: US 2009/0256834 A1
(43) Pub. Date: Oct. 15, 2009

(54) LIGHT EMITTING DEVICE AND DISPLAY DEVICE USING THE SAME

(76) Inventor: Byong-Gon Lee, Suwon-si (KR)

Correspondence Address: CHRISTIE, PARKER & HALE, LLP, PO BOX 7068, PASADENA, CA, 91109-7068, US

(21) Appl. No.: 12/361,489

(22) Filed: Jan. 28, 2009

(30) Foreign Application Priority Data
Apr. 15, 2008 (KR) 10-2008-0034734

(51) Int. Cl. G09G 3/20; G09G 3/34; G09G 5/00

(52) U.S. Cl. 345/214; 345/55; 345/84

(57) ABSTRACT

A light emitting device includes a plurality of scan lines for transferring light emitting scan signals including a combination of an emission-on voltage and an emission-off voltage. A plurality of data lines extend in a direction crossing the plurality of scan lines and are configured to transfer light emitting data voltages. A plurality of light emitting pixels are respectively formed in regions defined by the plurality of scan lines and the plurality of data lines and are configured to emit electrons by a difference between the emission-on voltage and the light emitting data voltage. During a period in which the light emitting scan signals have the emission-on voltage, at least one of the emission-on voltage and the light emitting data voltages alternately has a first voltage and a second voltage lower than the first voltage.

### CROSS-REFERENCE TO RELATED APPLICATION

This application claims priority to and the benefit of Korean Patent Application No. 10-2008-0034734 filed in the Korean Intellectual Property Office on Apr. 15, 2008, the entire content of which is incorporated herein by reference.

### BACKGROUND OF THE INVENTION

1. Field of the Invention

The present invention relates to a light emitting device and a display device employing the same.

2. Description of the Related Art

A liquid crystal display (LCD) is a kind of a display device that is adapted to implement images by changing the amount of light transmittance on a pixel basis by employing a dielectric anisotropic property of liquid crystal whose twist angle is changed depending on an applied voltage.

The LCD typically includes a liquid crystal panel assembly and a light emitting device disposed at the rear of the liquid crystal panel assembly and providing light to the liquid crystal panel assembly. One pixel of the light emitting device can be composed of a field emission array (FEA) type of electron emission device.

The electron emission device is driven by a constant voltage pulse having a duty ratio. However, the electron emission device may have an electron emission non-uniformity phenomenon in which an electron beam is not uniformly spread between electron emission devices due to structural factors such as processes or materials. Accordingly, luminous efficiency of a phosphor layer may be decreased.

More specifically, the electron emission device is driven by a constant voltage pulse applied to three electrodes, for example a gate electrode, a cathode, and an anode. Here, the three electrodes are separated from one other for driving. Electron emission regions, including the electron emission devices, are discontinuously arranged.

When a driving voltage is applied to the cathode and the gate electrode, electron beams generated from the electron emitters are attracted by the anode to which a high voltage is applied, thus colliding against the phosphor layer. However, if the electron beams are not spread sufficiently, some phosphor layers can have an excessive or insufficient current density due to electron beams that have not uniformly impacted on the phosphor layer, such that average luminous efficiency of the overall phosphor layers decreases.

### SUMMARY OF THE INVENTION

In accordance with the present invention a light emitting device and a display device employing the same having advantages of uniformly spreading electron beams is provided. An exemplary embodiment of the present invention provides a light emitting device including a plurality of scan lines for transferring light emitting scan signals including a combination of an emission-on voltage and an emission-off voltage. A plurality of data lines extend in a direction crossing the plurality of scan lines and are configured to transfer light emitting data voltages. A plurality of light emitting pixels are respectively formed in regions defined by the plurality of scan lines and the plurality of data lines and are configured to emit electrons by a difference between the emission-on voltage and the light emitting data voltage. During a period in which the light emitting scan signals have the emission-on voltage, at least one of the emission-on voltage and the light emitting data voltages alternately has a first voltage and a second voltage lower than the first voltage.

Another exemplary embodiment of the present invention provides a display device including: a display panel having a plurality of display scan lines for transferring display scan signals including a scan-on voltage and a scan-off voltage. A plurality of display data lines extend in a direction to cross the display scan lines and transfer the display data signals. A plurality of display pixels are defined by the plurality of display scan lines and the plurality of display data lines. A light emitting device includes a plurality of light emitting scan lines for transferring light emitting scan signals including a combination of an emission-on voltage and an emission-off voltage. A plurality of light emitting data lines extend in a direction to cross the plurality of light emitting scan lines and transfer light emitting data voltages. A plurality of light emitting pixels are respectively formed in regions defined by the plurality of light emitting scan lines and the plurality of light emitting data lines and are configured to emit electrons by a difference between the emission-on voltage and the light emitting data voltage. During a period in which the light emitting scan signals have the emission-on voltage, at least one of the emission-on voltage and the light emitting data voltages alternately has a first voltage and a second voltage lower than the first voltage.

Still another exemplary embodiment of the present invention provides a method of driving a light emitting device, including a plurality of first electrodes, a plurality of second electrodes insulated from the plurality of first electrodes and crossing the first electrodes, and a plurality of electron emitters formed in regions where the plurality of first electrodes crosses the plurality of second electrodes. The method includes the steps of sequentially applying a first voltage to at least one of the plurality of first electrodes, and applying a second voltage to at least one of the plurality of second electrodes. The plurality of electron emission units formed in the regions where the first electrodes applied with the first voltage and the second electrodes applied with the second voltage emit electrons by a difference between the first voltage and the second voltage, and the first voltage alternately has a third voltage and a fourth voltage lower than the third voltage.

As described above, according to the present invention, electron beams can be spread uniformly, and therefore luminous efficiency can be improved.

### BRIEF DESCRIPTION OF THE DRAWINGS

FIG. 1 is a simplified schematic diagram of a display device in accordance with an exemplary embodiment of the present invention.

FIG. 2 is a block diagram of a light emitting device in the display device in accordance with an exemplary embodiment of the present invention.

FIG. 3 shows an example of a partial perspective view of the light emitting unit in the light emitting device shown in FIG. 2.

FIG. 4 is a partial cross-sectional view taken along line IV-IV′ in the light emitting unit shown in FIG. 3.

FIG. 5 shows another example of a partial perspective view of the light emitting unit in the light emitting device shown in FIG. 2.

FIG. 6 is a view showing an example of an emission-on voltage of the light emitting device shown in FIG. 2.

FIG. 7 is a view showing a shape in which electron beams are impacted in the light emitting device.

FIG. 8 is a view showing a spreading path of electron beams.

FIG. 9 shows a waveform diagram of light emitting scan signals of the light emitting device in accordance with an exemplary embodiment of the present invention.

FIGS. 10A, 10B, 10C and 10D are diagrams showing exemplary driving waveforms of the light emitting scan signals shown in FIG. 9.

FIG. 11 is a diagram showing spreading results of electron beams according to the driving waveform of FIG. 9.

FIG. 12 is a diagram showing a shape in which electron beams are impacted in accordance with an exemplary embodiment of the present invention.

FIG. 13 is a block diagram of a LCD in accordance with an exemplary embodiment of the present invention.

FIG. 14 is an equivalent circuit diagram of one display pixel in the LCD in accordance with an exemplary embodiment of the present invention.

### DETAILED DESCRIPTION OF THE EMBODIMENTS

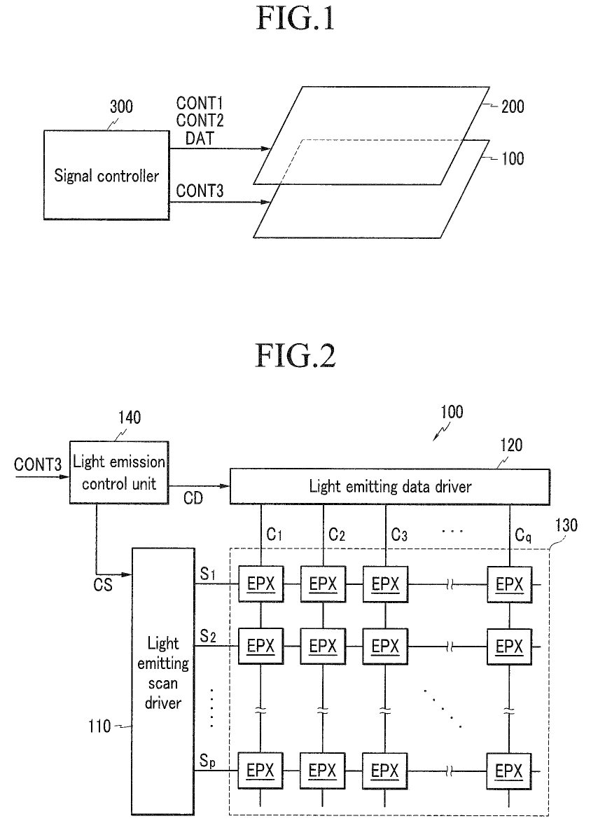

Referring to FIG. 1, the display device in accordance with an exemplary embodiment of the present invention includes a display unit 200, a light emitting device 100, and a signal controller 300. The display unit 200 is controlled by the signal controller 300 which provides signals CONT1, CONT2 and DAT to display unit 220. Light emitting device 100 is also controlled by the signal controller 300 which provides signal CONT3 to light emitting device 100. The display unit 200 displays images by employing light provided from the light emitting device 100. The display unit 200 includes a plurality of display pixels (not shown) arranged in an approximate matrix form.

Referring to FIG. 2, the light emitting device 100 includes a light emitting scan driver 110, a light emitting data driver 120, a light emitting portion 130, and a light emission control unit 140.

The light emitting portion 130 includes a plurality of light emitting signal lines S₁-Sₚ and C₁-C_{q} and a plurality of light emitting pixels EPX, when viewed from the equivalent circuit view. The light emitting pixels EPX are connected to the plurality of light emitting signal lines and arranged in an approximate matrix form.

The light emitting signal lines S₁-Sₚ and C₁-C_{q} include a plurality of light emitting scan lines S₁-Sₚ for transferring light emitting scan signals, and a plurality of light emitting data lines C₁-C_{q} for transferring light emitting data voltages. The plurality of light emitting scan lines S₁-Sₚ extend in an approximate row direction and are substantially parallel to one another, and the plurality of light emitting data lines C₁-C_{q} extend in an approximate column direction and are substantially parallel to one another.

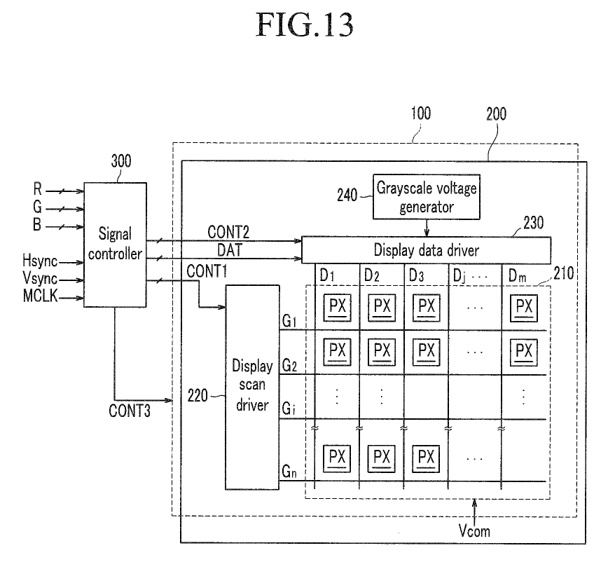

Each light emitting pixel EPX corresponds to a number of display pixels of a display panel 210 (see FIG. 13). In other words, one light emitting pixel EPX corresponds to (N*M) display pixels defined by N (N is an integer greater than 1) rows and M (M is an integer greater than 1) columns in the display unit 200.

For example, assuming that 1024 display pixels are formed in a row direction and 768 display pixels are formed in a column direction in the display unit 200, and each of N and M is 4, 256 light emitting pixels EPX can be formed in the row direction and 192 light emitting pixels EPX can be formed in the column direction in the light emitting portion 130, and one light emitting pixel EPX can correspond to 16 display pixels.

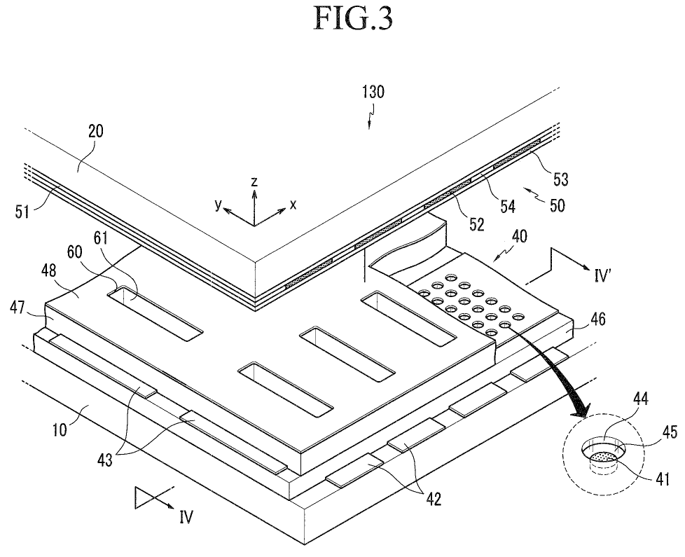

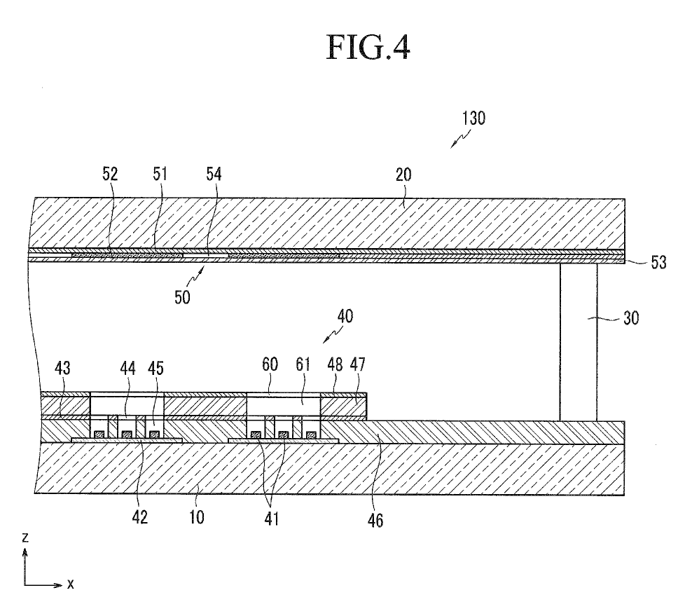

Referring to FIGS. 3 and 4, the light emitting portion 130 includes two substrates 10, 20 that face each other, and a sealing member 30 disposed between the substrates 10, 20 and joining the substrates 10, 20 together. The substrates 10, 20 and the sealing member 30 constitute a vacuum container. The inside of the vacuum container can be maintained to a vacuum degree of, for example, approximately 10⁻⁶ Torr.

The region of the substrates 10, 20 disposed within the sealing member 30 is divided into a valid region actually contributing to visible light emission and an invalid region surrounding the valid region. A plurality of electron emission units 40 for electron emission are located in the valid region over the substrate 10. Light emitting units 50 for visible light emission are located in the valid region over the substrate 20.

The substrate 20 where the light emitting units 50 are located can be set to be a front substrate of the light emitting portion 130, and the substrate 10 where the electron emission units 40 are located can be set to be a rear substrate of the light emitting portion 130.

A plurality of driving electrodes 42, 43 is formed on the substrate 10. Each of the electron emission units 40 includes an electron emitter 41 and a part of the driving electrodes 42, 43. The driving electrodes 42, 43 control the amount of electron emission of the electron emitter 41. The plurality of driving electrodes 42, 43 include a plurality of cathodes 42 extending in a y-axis direction and gate electrodes 43 extending in an x-axis direction. The gate electrodes 43 extend in a direction crossing the cathodes 42 over the cathodes 42 with an insulation layer 46 between the gate electrodes 43 and the cathodes 42. In the light emitting device 100 shown in FIG. 2, the plurality of gate electrodes 43 form the plurality of light emitting scan lines S₁-Sₚ, respectively, and the plurality of cathodes 42 form the plurality of light emitting data lines C₁-C_{q}, respectively. However, alternatively, the plurality of cathodes 42 may form the plurality of light emitting scan lines S₁-Sₚ, respectively, and the plurality of gate electrodes 43 may form the plurality of light emitting data lines C₁-C_{q}, respectively.

Openings 44, 45 are respectively formed in the gate electrode 43 and the insulation layer 46 at every crossing region of the cathodes 42 and the gate electrodes 43, thus exposing a part of the surface of the cathode 42. The electron emitter 41 is located on the cathode 42 within the openings 44, 45.

The electron emitter 41 can include materials that emit electrons when being applied with an electric field under a vacuum, for example a carbon-based material or a material of a nanometer size. The electron emitter 41 can include a material selected from the group consisting of carbon nanotubes, graphite, graphite nanofibers, diamond, diamond-like carbon, fullerene (C₆₀), silicon nanowire, and combinations thereof. The electron emitter 41 can have a tip structure having a tapered front end including molybdenum (Mo), silicon (Si), or the like as an integral material.

One of the crossing regions of the cathodes 42 and the gate electrodes 43 may correspond to one light emitting pixel EPX of the light emitting portion 130, or two or more of the crossing regions thereof may correspond to one light emitting pixel EPX of the light emitting portion 130.

Each of the light emitting units 50 includes an anode 51, a phosphor layer 52 disposed on one side of the anode 51, and a metal reflective layer 53 covering the phosphor layer 52. The anode 51 is applied with an anode voltage from a power source unit (not shown) outside the vacuum container, and maintains the phosphor layer 52 at a high potential state. The anode 51 can be formed of a transparent conductive layer such as indium tin oxide (ITO) so that visible light radiated from the phosphor layer 52 can transmit therethrough.

The metal reflective layer 53 can be thinly formed of aluminum at a thickness of, for example, several thousands of angstroms. Micro-holes through which electron beams can pass are formed in the metal reflective layer 53. Of the visible light radiated from the phosphor layer 52, the metal reflective layer 53 reflects toward the substrate 20 the visible light that is radiated toward the substrate 10, thereby increasing luminance of the light emitting surface thereof. The anode 51 may be omitted and the metal reflective layer 53 may operate as an anode according to an anode voltage applied thereto.

The light emitting unit 50 further includes a dark-colored layer 54 formed of chromium or the like. The phosphor layer 52 is formed at a location on the anode 51 corresponding to a region in which the electron emission unit 40 is formed. The dark-colored layer 54 is formed between neighboring phosphor layers 52, that is, at a location corresponding to a region in which the electron emission unit 40 is not formed. However, alternatively, the entire anode 51 may be covered with the phosphor layer 52.

A plurality of spacers (not shown) may be formed in the valid region between the two substrates 10, 20. The spacers function to support a compressive force applied to the vacuum container maintain the distance between the two substrates 10, 20 constant. When a difference between driving voltages applied to the cathodes 42 and the gate electrodes 43 exceeds a threshold value, an electric field is formed around the electron emitters 41 and electrons are emitted as a result of the electric field. The emitted electrons are attracted by an anode voltage, for example a positive voltage of several thousands of volts that is applied to the anode 51, and then collide against a corresponding phosphor layer 52 to thus emit light. That is, the light emission intensity of the phosphor layer 52 corresponds to the amount of electron beam emission.

The light emitting portion 130 further includes an insulation layer 47 covering the gate electrodes 43, and a condensing electrode 48 formed on the insulation layer 47. Condensing electrode opening 60 and insulation layer opening 61 through which electron beams can pass are formed in the condensing electrode 48 and the insulation layer 47, respectively. The condensing electrode 48 is applied with a negative DC voltage of several to several tens of volts, and functions to condense electrons passing through the condensing electrode opening 60.

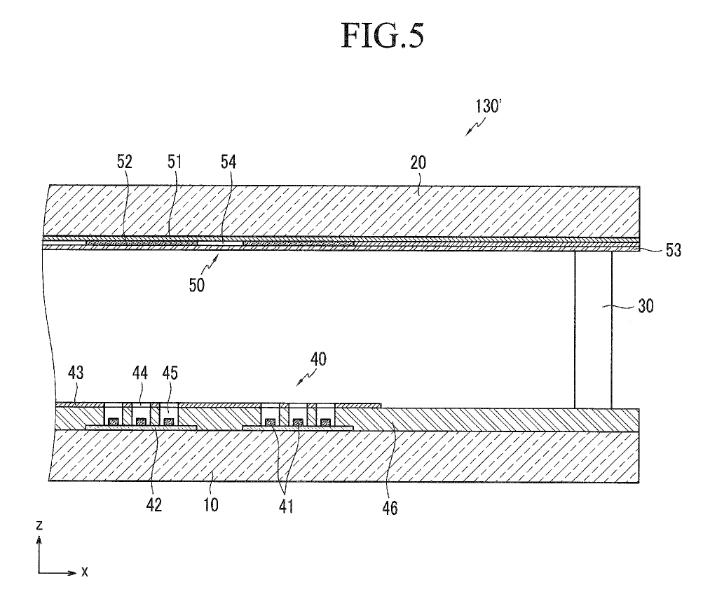

However, alternatively, the condensing electrode 48 and the insulation layer 47 may be eliminated as shown in a light emitting portion 130′ of FIG. 5.

Referring back to FIG. 2, the light emission control unit 140 generates a light emitting scan control signal CS and a light emitting data control signal CD in response to a light emission control signal CONT3 from the signal controller 300, and controls the light emitting scan driver 110 and the light emitting data driver 120 using the light emitting scan control signal CS and the light emitting data control signal CD, respectively.

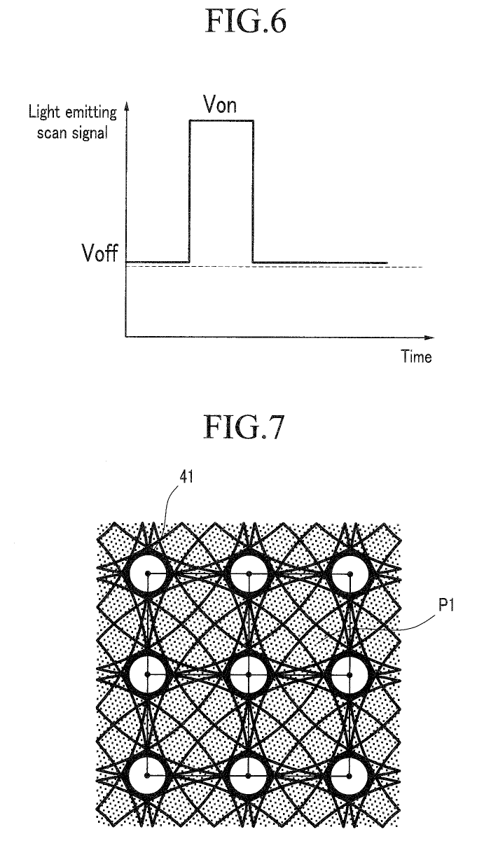

The light emitting scan driver 110 is connected to the light emission scan lines S₁-Sₚ of the light emitting portion 130, and sequentially applies a light emitting scan signal to the light emission scan lines S₁-Sₚ in response to the light emitting scan control signal CS received from the light emission control unit 140. The light emitting scan signal consists of a combination of an emission-on voltage Von and an emission-off voltage Voff. When the light emission scan lines S₁-Sₚ correspond to the gate electrodes 43, the emission-on voltage Von can be set to a high voltage and the emission-off voltage Voff can be set to a low voltage, as shown in FIG. 6.

The light emitting data driver 120 is connected to the light emitting data lines C₁-C_{q} of the light emitting portion 130. The light emitting data driver 120 generates a plurality of light emitting data voltages, which will be applied to the plurality of light emitting data lines C₁-C_{q}, in response to the light emitting data control signal CD received from the light emission control unit 140, and transfers the generated light emitting data voltages to the light emitting data lines C₁-C_{q}. This light emitting data voltage may be a positive voltage or a negative voltage that is lower than the emission-on voltage Von.

The light emitting data driver 120 can select one of the plurality of voltages according to a representative grayscale, which will be represented in a number of display pixels of the display panel 210 (see FIG. 13) corresponding to the light emitting pixel EPX to which the light emitting data voltage will be applied, and can set the selected voltage as a light emitting data voltage. Therefore, the light emitting pixel EPX emits light with a luminance corresponding to the representative grayscale. The representative grayscale can be the highest grayscale of grayscales to be represented in a number of display pixels.

Alternatively, the light emitting data voltage can have a constant value irrespective of input video signals R, G, B input to the signal controller 300. Thus, the light emitting pixel EPX would emit light with constant luminance irrespective of the grayscale to be represented in a corresponding number of display pixels PX.

This light emitting operation of the light emitting device 100 will now be described in more detail.

The light emitting data driver 120 generates light emitting data voltages corresponding to the light emitting pixels EPX of one row in response to the light emitting data control signal CD received from the light emission control unit 140, and applies the generated light emitting data voltages to the light emitting data lines C₁-C_{q}.

The light emitting scan driver 110 applies the emission-on voltage Von to the light emission scan lines S₁-Sₚ in response to the light emitting scan control signal CS received from the light emission control unit 140. Accordingly, electron beams are emitted from the electron emitters 41 (see FIGS. 3, 4 and 5) due to a voltage difference between the light emitting data voltages applied to the light emitting data lines C₁-C_{q}, that is, the cathodes 42 and the emission-on voltage Von applied to the light emission scan lines S₁-Sₚ, that is, the gate electrodes 43. The emitted electron beams collide with the phosphor layer 52 so that the light emitting pixels EPX emit light.

As the above process is repeated, the emission-on voltage Von is sequentially applied to all light emission scan lines S₁-Sₚ, and the light emitting data voltages are sequentially applied to the light emitting pixels EPX. Consequently, all light emitting pixels EPX are light-emitted and therefore light is supplied to the display unit 200.

However, if the electron beams emitted from the electron emitters 41 are not uniformly spread on the phosphor layers 52, the electron beams do not impact on the phosphor layers 52 where the electron emitters 41 are located, so that invalid light emitting surfaces P1 may be formed, as shown in FIG. 7. That is, an electron emission non-uniformity phenomenon in which electron beams are not uniformly spread may occur.

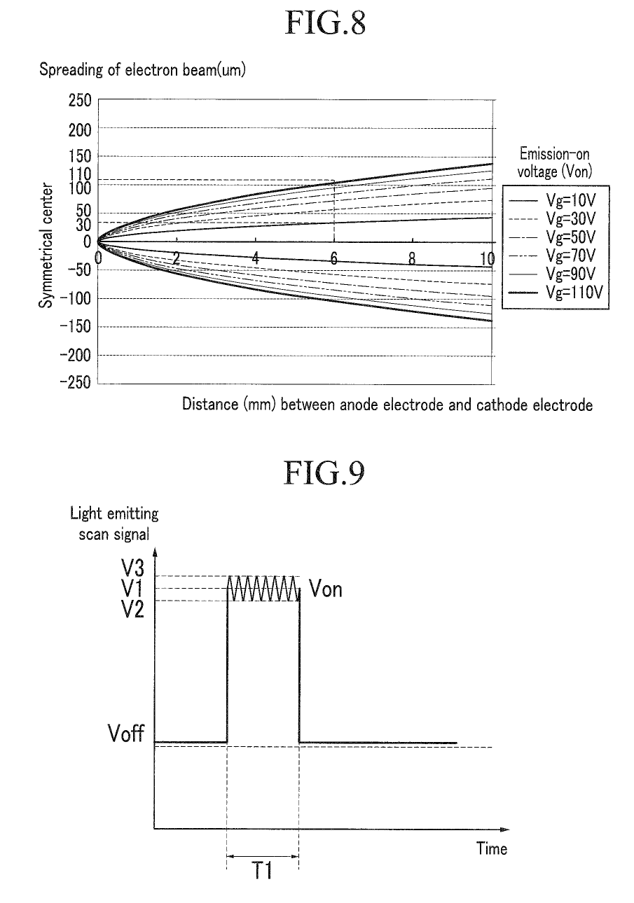

FIG. 8 is a view showing a spreading path of electron beams.

From FIG. 8, it can be seen that the amount of electron beam emission and the path of an electron beam vary depending on a voltage difference between the emission-on voltage Von applied to the gate electrode 43 and the light emitting data voltage applied to the cathode 42. In FIG. 8, it is assumed that the light emitting data voltage is constant.

More specifically, when the emission-on voltage Von applied to the gate electrode 43 gradually rises, a voltage difference between the light emitting data voltage applied to the cathode 42 and the emission-on voltage Von gradually increases. Thus, the spreading area of an electron beam emitted from the electron emitter 41 can be expanded. In other words, the electron beam has a gradually expanding distribution as the emission-on voltage Von applied to the gate electrode 43 gradually rises, so that it is gradually more distant from a symmetrical center of the electron beam spreading axis. For example, when a distance between the cathode 42 and the anode 51 is 6 mm and the emission-on voltage Von applied to the gate electrode 43 is 10V, an electron beam emitted from the electron emitter 41 can expand from the symmetrical center to 30 μm according to a voltage difference between the light emitting data voltage applied to the cathode 42 and the emission-on voltage Von of 10V. Further, if the emission-on voltage Von applied to the gate electrode 43 gradually rises and reaches 110V, an electron beam emitted from the electron emitter 41 can expand from the symmetrical center to 110 μm according to a voltage difference between the light emitting data voltage applied to the cathode 42 and the emission-on voltage Von of 110V.

If a minute pulse change occurs in the emission-on voltage Von due to this characteristic while the emission-on voltage Von is applied to the gate electrode 43, the impacted region of the electron beam is gradually expanded, so that the electron beam emitted from the electron emitter 41 can be expanded uniformly.

Hereinafter, a method of uniformly spreading an electron beam is described with reference to FIGS. 9 to 12.

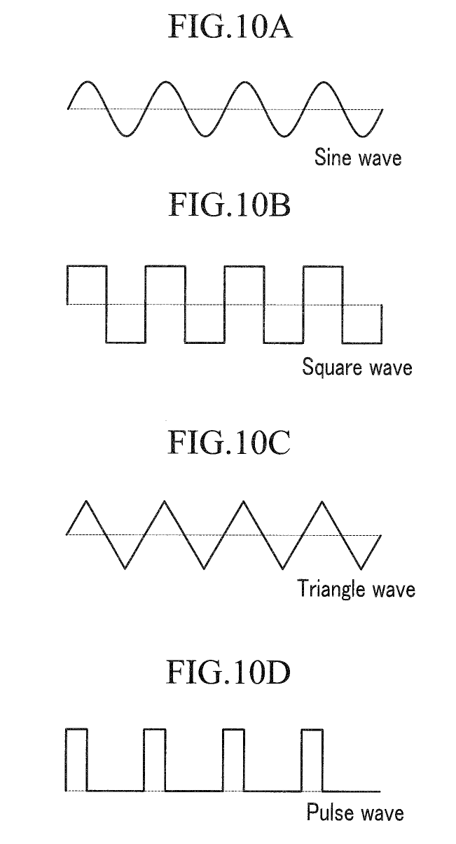

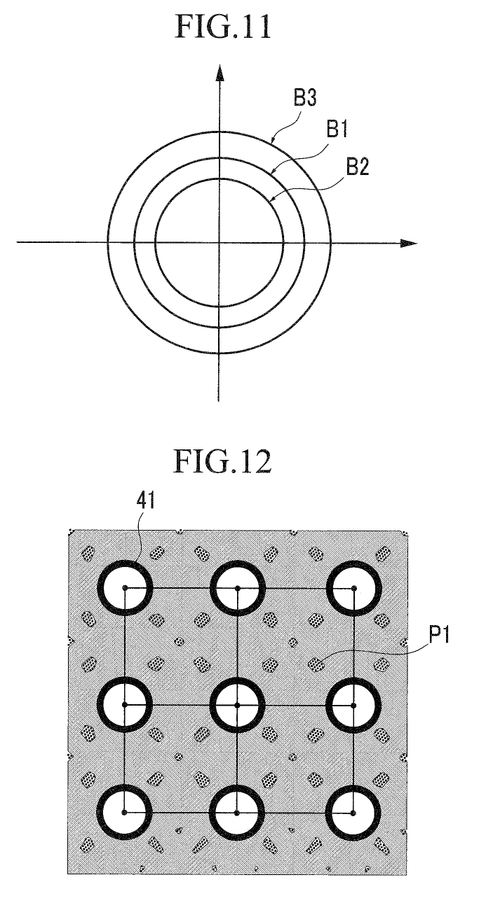

FIG. 9 shows a waveform diagram of light emitting scan signals of the light emitting device in accordance with an exemplary embodiment of the present invention. FIGS. 10A to 10D are diagrams showing exemplary driving waveforms of the light emitting scan signals shown in FIG. 9, and FIG. 11 is a diagram showing spreading results of electron beams according to the driving waveform of FIG. 9. FIG. 12 is a diagram showing a shape in which electron beams are impacted in accordance with an exemplary embodiment of the present invention.

Referring to FIGS. 9 and 10A to 10D, during a period T1 in which the emission-on voltage Von of the light emitting scan signal is applied to the gate electrode 43, the emission-on voltage Von can be formed to have a micro-waveform having at least one cycle. Further, the emission-on voltage Von may have a voltage between at least two voltages according to the micro-waveform. In an exemplary embodiment of the present invention, the micro-waveform of the emission-on voltage Von may be a sine wave, a square wave, a triangle wave, and a pulse wave respectively shown in FIGS. 10A to 10D, or the like, but is not limited thereto.

As an example, the light emitting scan driver 110 can set a central voltage V1 of the emission-on voltage Von to 100V. Further, the light emitting scan driver 110 can set a voltage V2 to be lower than the central voltage V1 of the emission-on voltage Von (hereinafter referred to as a “central lowest voltage”) and a voltage V3 to be higher than the central voltage V1 (hereinafter referred to as a “central highest voltage), at 75V and 125V, respectively. The micro-waveform of the emission-on voltage Von has at least one cycle between the central lowest voltage V2 and the central highest voltage V3. During the period T1 in which the emission-on voltage Von is applied to the gate electrode 43, if the light emitting data voltage is applied to the data lines C₁-C_{q} according to the light emitting data control signal CD received from the light emission control unit 140, the electron emitter 41 emits an electron beam B2 according to a voltage difference between the central lowest voltage V2 of the emission-on voltage Von and the light emitting data voltage. Further, the electron emitter 41 emits an electron beam B1 according to a voltage difference between the central voltage V1 of the emission-on voltage Von and the light emitting data voltage, and emits an electron beam B3 according to a voltage difference between the central highest voltage V3 of the emission-on voltage Von and the light emitting data voltage.

The emitted electron beams B1, B2, B3 are gradually spread according to the central lowest voltage V2, the central voltage V1, and the central highest voltage V3 applied to the gate electrodes 43, as shown in FIG. 11, and can be then uniformly impacted on the phosphor layer 52. In other words, the electron beam B3 generated by the central highest voltage V3 is spread farther than the electron beam B1 generated from the central voltage V1, and the electron beam B1 generated by the central voltage V1 is spread farther than the electron beam B2 generated by the central lowest voltage V2.

As described above, in accordance with an exemplary embodiment of the present invention, during the period T1 in which the emission-on voltage Von of the light emission control signal is applied to the gate electrode 43, the electron beam spread by the micro-waveform can be spread more widely than the electron beam spread using only the central voltage V1. That is, as the central lowest voltage V2 and the central highest voltage V3 of the minute pulse waveform are periodically applied to the gate electrode 43, the electron beams B2, B3 around the electron beam B1 can be impacted on the phosphor layer 52 by the central voltage V1. Accordingly, as shown in FIG. 12, electron beams are also spread to the phosphor layers 52 in which the electron emitters 41 are not located and uniformly impacted on the phosphor layers 52, so that the invalid light emitting surfaces P1 can be reduced.

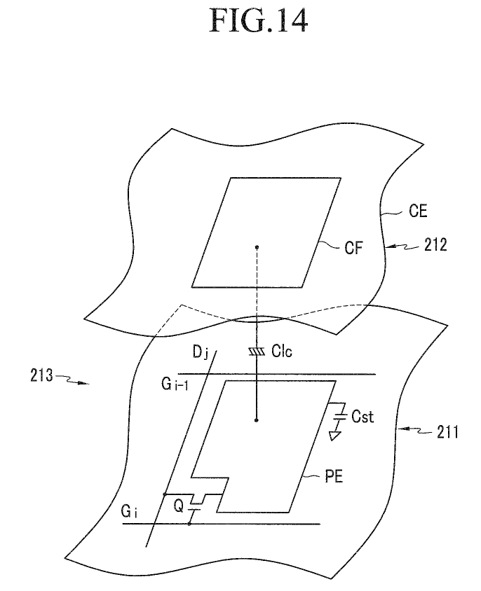

An example of a display device using this light emitting device as a light emitting source is described in detail in connection with an LCD with reference to FIGS. 13 and 14.

FIG. 13 is a block diagram of a LCD in accordance with an exemplary embodiment of the present invention, and FIG. 14 is an equivalent circuit diagram of one display pixel in the LCD in accordance with an exemplary embodiment of the present invention.

As shown in FIG. 13, the display device includes a light emitting device 100, a display unit 200 and a signal controller 300. The display unit 200 includes a display panel 210, a display scan driver 220 and a display data driver 230 connected to the display panel 210, and a grayscale voltage generator 240 connected to the display data driver 230.

The display panel 210 includes a plurality of display signal lines G₁-Gₙ, D₁-Dₘ, and a plurality of display pixels PX connected to the signal lines and arranged in an approximate matrix form. The display signal lines G₁-Gₙ, D₁-Dₘ include a plurality of display scan lines G₁-Gₙ for transferring display scan signals, and a plurality of display data lines D1-Dm for transferring display data signals, that is, display data voltages.

Referring to FIG. 14, each display pixel PX, for example a display pixel PX connected to an i^{th} (i=1, 2, . . . , n) display scan line Gᵢ and a j^{th} (j=1,2, . . . m) display data line Dⱼ, includes a switching element Q connected to the display signal lines Gᵢ, Dⱼ, and a liquid crystal capacitor Clc and a sustain capacitor Cst connected to the switching element Q. The sustain capacitor Cst may be omitted, if appropriate.

The switching element Q is a three-terminal element such as a thin film transistor included in a rear display plate 211. The switching element Q has a control terminal connected to the display scan line Gᵢ, an input terminal connected to the display data line Dⱼ, and an output terminal connected to the liquid crystal capacitor Clc and the sustain capacitor Cst.

The liquid crystal capacitor Clc uses a common electrode CE of a front display plate 212 and a pixel electrode PE of the rear display plate 211 as two terminals. A liquid crystal layer 213 between the two electrodes PE, CE functions as a dielectric material. The pixel electrode PE is connected to the switching element Q. The common electrode CE is formed on a front surface of the front display plate 212 and is applied with a common voltage Vcom. Unlike FIG. 14, there is a case where the common electrode CE is provided in the rear display plate 211. In this case, at least one of the two electrodes PE, CE may be linear or bar-shaped.

The sustain capacitor Cst, playing an auxiliary role of the liquid crystal capacitor Clc, is formed by an additional signal line (not shown) provided in the front display plate 212 and the pixel electrode PE with an insulator interposed therebetween. A voltage such as the common voltage Vcom is applied to the additional signal line. However, the sustain capacitor Cst may be formed by the pixel electrode PE and a front-stage scan line immediately on an insulator with the insulator interposed therebetween.

In order to implement color display, each display pixel PX can uniquely display any one of primary colors (space division), or each display pixel PX can alternately display the primary colors as times passes (temporal division). A desired color is recognized as the spatial or temporal sum of the primary colors. For example, the primary colors can include the three primary colors of red, green, and blue. In the case of the spatial division, three display pixels respectively displaying red, green, and blue constitute a dot, that is, the basic unit of an image. FIG. 14 shows an example of spatial division. This drawing illustrates that each display pixel PX includes a color filter CF representing one of the primary colors in the region of the front display plate 212. However, alternatively, the color filter CF may be disposed on or below the pixel electrode PE of the rear display plate 211.

The display panel 210 is equipped with at least one polarizer (not shown).

Referring back to FIG. 13, the display scan driver 220 is connected to the display scan lines G₁-Gₙ of the display panel 210, and supplies the display scan lines G₁-Gₙ with the display scan signals composed of a combination of the scan-on voltage and the scan-off voltage.

The display data driver 230 is connected to the display data lines D₁-Dₘ of the display panel 210. The display data driver 230 selects grayscale voltages from the grayscale voltage generator 240 and applies the selected grayscale voltages to the data lines D₁-Dₘ as data signals. However, in the case in which the grayscale voltage generator 240 does not provide all voltages for the entire grayscales, but provides only a number of reference grayscale voltages, the display data driver 230 divides the reference grayscale voltages, generates grayscale voltages for the entire grayscales, and selects data signals from the generated grayscale voltages.

The grayscale voltage generator 240 generates the entire grayscale voltages pertinent to luminance of the pixel PX or a number of grayscale voltages (hereinafter referred to as “reference grayscale voltages”).

The signal controller 300 controls the display scan driver 220, the display data driver 230, and the light emitting device 100. The signal controller 300 receives input video signals R, G, B and input control signals for controlling the display of the input video signals R, G, B from an external graphics controller (not shown). The input video signals R, G, B include luminance information of each pixel PX. The luminance has a number, for example 1024 (=2¹⁰), 256(=2⁸), or 64(=2⁶) grayscales. For example, the input control signals can include a vertical synchronization signal Vsync, a horizontal synchronization signal Hsync, a main clock signal MCLK, and so on.

The signal controller 300 properly processes the input video signals R, G, B to be suitable for an operation condition of the display panel 210 on the basis of the input video signals R, G, B and the input control signals, and generates a scan control signal CONT1, a data control signal CONT2, and a light emitting device control signal CONT3. Then, the signal controller 300 applies the scan control signal CONT1 to the display scan driver 220, a processing result of the data control signal CONT2 and a video signal DAT to the display data driver 230, and the light emitting device control signal CONT3 to the light emitting device 100. In order for the light emitting operation of the light emitting device 100 to operate in conjunction with the display operation of the display unit 200, the light emitting device control signal CONT3 can include signals corresponding to the video signal DAT, the scan control signal CONT1, and the data control signal CONT2.

Now, the display operation of the LCD is described in more detail.

Referring to FIGS. 2 and 13, the display data driver 230 receives the digital video signal DAT with respect to the display pixels PX of one row in response to the data control signal CONT2 received from the signal controller 300, and selects a grayscale voltage corresponding to each digital video signal DAT. The display data driver 230 then converts the digital video signal DAT into an analog data voltage and applies the converted voltage to corresponding display data lines D₁-Dₘ.

The display scan driver 220 applies a scan-on voltage to the display scan lines G₁-Gₙ in response to the scan control signal CONT1 received from the signal controller 300, thus turning on the switching element Q connected to the scan lines G₁-Gₙ. Thus, the data voltages applied to the display data lines D₁-Dₘ are applied to corresponding display pixels PX through the turned-on switching element Q.

The light emission control unit 140 transfers the light emitting scan control signal CS and the light emitting data control signal CD to the light emitting scan driver 110 and the light emitting data driver 120, respectively, in response to the light emitting device control signal CONT3 received from the signal controller 300 so that the light emitting pixels EPX of one row corresponding to the display pixels PX of the corresponding row can emit light. Accordingly, light is supplied to the display unit 200 by light emission of the light emitting pixels EPX.

A difference between the data voltage applied to the display pixel PX and the common voltage Vcom appears as a charged voltage of the liquid crystal capacitor Clc, that is, a pixel voltage. Liquid crystal molecules are differently oriented depending on the amount of a pixel voltage. Thus, polarization of light passing through the liquid crystal layer 213, which is supplied from the light emitting pixel EPX of the light emitting device 100, is changed. This change of the polarization appears as a change of transmittance of the light by a polarizer. It causes the display pixel PX to display luminance indicating the grayscale of the video signal DAT.

As this process is repeated using 1 horizontal period (which can be identical to one cycle of the horizontal synchronization signal Hsync) as a unit, the scan-on voltage is sequentially applied to all display scan lines G₁-Gₙ and the data voltage is applied to all display pixels PX, thus displaying an image of one frame. Further, the light emitting device 100 repeats this process as N times cycle units of 1 horizontal period. That is, the light emitting device 100 can supply light to the display panel 210 while the display panel 210 displays an image of one frame, by repeating the process of emitting light from the light emitting pixels EPX of one row in response to the display pixels PX of N rows.

In the light emitting device in accordance with an exemplary embodiment of the present invention, in order for electron beams to be uniformly spread and then impacted on the phosphor layer 52, the emission-on voltage Von of the light emission control signal is made to have a micro-waveform having at least 1 cycle. Further, the emission-on voltage Von can have voltages between at least two voltages depending on the micro-waveform.

As described above, during a period in which electron beams are emitted from the electron emitters 41 in accordance with an exemplary embodiment of the present invention, the emission-on voltage Von of the light emission control signal has voltages between at least two voltages. Accordingly, electron beams can be spread uniformly and therefore luminous efficiency of a display device can be improved.

In an exemplary embodiment of the present invention, a micro-waveform is formed in the emission-on voltage Von applied to the gate electrodes 43 in order to uniformly spread electron beams. However, the present invention is not limited to the embodiment. For example, electron beams can be spread uniformly by forming a micro-waveform in the light emitting data voltage applied to the cathodes 42.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A light emitting device comprising:
a plurality of scan lines for transferring light emitting scan signals, the light emitting scan signals comprising a combination of an emission-on voltage and an emission-off voltage;
a plurality of data lines extending in a direction crossing the plurality of scan lines for transferring light emitting data voltages; and
a plurality of light emitting pixels, each pixel being in respective regions defined by the plurality of scan lines and the plurality of data lines and configured to emit electrons by a difference between the emission-on voltage and the light emitting data voltage,
wherein during a period in which the light emitting scan signals have the emission-on voltage, at least one of the emission-on voltage and the light emitting data voltages alternately has a first voltage and a second voltage lower than the first voltage.

2. The light emitting device of claim 1, wherein
the emission-on voltage alternately has the first voltage and the second voltage.

3. The light emitting device of claim 1, wherein:
the at least one voltage includes a waveform repeated at least every cycle, and
the waveform has the first voltage and the second voltage as a highest voltage and a lowest voltage, respectively.

4. The light emitting device of claim 3, wherein
the waveform has any one of a sine wave, a square wave, a triangle wave, and a pulse wave.

5. The light emitting device of claim 1, wherein
each light emitting pixel comprises:
an electron emission unit for emitting electrons; and
a light emitting unit opposite to the electron emission unit for emitting light in response to the electrons emitted from the electron emission unit.

6. The light emitting device of claim 5, wherein:
the scan lines include first electrodes;
the data lines include second electrodes; and
the electron emission unit includes a plurality of electron emitters formed on any one of the first electrodes and the second electrodes in regions where the first electrodes cross the second electrodes.

7. The light emitting device of claim 5, wherein the light emitting unit comprises:
a third electrode to which a positive voltage is applied; and
a phosphor layer formed on the third electrode.

8. A display device comprising:
a display panel, including a plurality of display scan lines for transferring display scan signals having a scan-on voltage and a scan-off voltage, a plurality of display data lines extending in a direction to cross the display scan lines and transferring display data signals, and a plurality of display pixels defined by the plurality of display scan lines and the plurality of display data lines; and
a light emitting device, including a plurality of light emitting scan lines for transferring light emitting scan signals having a combination of an emission-on voltage and an emission-off voltage, a plurality of light emitting data lines extending in a direction to cross the plurality of light emitting scan lines and transferring light emitting data voltages, and a plurality of light emitting pixels respectively formed in regions defined by the plurality of light emitting scan lines and the plurality of light emitting data lines and configured to emit electrons by a difference between the emission-on voltage and the light emitting data voltage,
wherein during a period in which the light emitting scan signals have the emission-on voltage, at least one of the emission-on voltage and the light emitting data voltages alternately has a first voltage and a second voltage lower than the first voltage.

9. The display device of claim 8, wherein the emission-on voltage alternately has the first voltage and the second voltage.

10. The display device of claim 9, wherein:
the at least one voltage includes a waveform repeated at least every cycle;
the waveform has the first voltage and the second voltage as a highest voltage and a lowest voltage, respectively; and
the waveform has any one of a sine wave, a square wave, a triangle wave, and a pulse wave.

11. A method of driving a light emitting device having a plurality of first electrodes, a plurality of second electrodes insulated from the plurality of first electrodes and crossing the first electrodes, and a plurality of electron emitters formed in regions where the plurality of first electrodes crosses the plurality of second electrodes, the method comprising:
sequentially applying a first voltage to at least one of the plurality of first electrodes; and
applying a second voltage to at least one of the plurality of second electrodes,
wherein the plurality of electron emission units in the regions where the first electrodes applied with the first voltage and the second electrodes applied with the second voltage emit electrons by a difference between the first voltage and the second voltage, and
wherein the first voltage alternates between a third voltage and a fourth voltage lower than the third voltage.

12. The method of claim 11, wherein when the first voltage is higher than the second voltage, the first electrodes are gate electrodes.

13. The method of claim 11, wherein when the second voltage is higher than the first voltage, the second electrodes are gate electrodes.
